(19) United States
(12) Patent Application Publication
(10) Pub. No.: US 2020/0219273 A1
(43) Pub. Date: Jul. 9, 2020

(54) SURFACE ROUGHNESS MEASUREMENT

(71) Applicant: ROLLS-ROYCE plc, London (GB)

(72) Inventors: Vadakke Matham MURUKESHAN, Derby (GB); Patinharekandy PRABHATHAN, Derby (GB); Aswin HARIDAS, Derby (GB); Pulkit KAPUR, Derby (GB); Bilal M. NASSER, Derby (GB); Kelvin H K CHAN, Derby (GB)

(21) Appl. No.: 16/734,503

(22) Filed: Jan. 6, 2020

(30) Foreign Application Priority Data
Jan. 8, 2019 (GB) 1900225.2

(51) Int. Cl. G06T 7/41; G06T 7/521; H04N 13/128; H04N 13/156; G06T 7/593

(52) U.S. Cl. CPC G06T 7/41; G06T 7/521; H04N 13/128; H04N 13/246; G06T 7/593; G06T 2207/10012; H04N 13/156

(57) ABSTRACT

A method of measuring the surface roughness of a component using an optical system comprising a tunable laser light source and a camera system. Positioning the component to be measured upon a mount in front of the optical system. Capturing a first image of the component at a first location at a first wavelength λ₁, and then capturing a second image of the component at the first location at a second wavelength λ₂. Determining the Speckle Statistical Correlation (SSC) coefficient of the first and second images. Plotting the SSC coefficient for the combined first and second images. Calculating the roughness parameters Rₐ and R_{q} from the SSC coefficient plot. Plotting a roughness map for the imaged surface from the calculated roughness parameters Rₐ and R_{q}. Moving the optical system to a new location and repeating steps (b) to (f) at the new location, and repeating these steps until a desired area of the component has been imaged. Stitching the roughness maps for each location to form an overall roughness map for the desired area of the component.

### CROSS-REFERENCE TO RELATED APPLICATIONS

This specification is based upon and claims the benefit of priority from United Kingdom patent application number GB 1900225.2 filed on Jan. 8, 2019, the entire contents of which are incorporated herein by reference.

### BACKGROUND

### Field of the Disclosure

The present disclosure concerns a method for measuring the surface roughness of a component, especially a large flat or curved component such as a blade for a gas turbine engine.

### Background of the Disclosure

Measuring the surface roughness of a material is important for determining information regarding the performance of a component as well as being able to detect faults or issues in the formation of the components. Current design requirements of the aerospace industry of to improving quality, strength and load carrying of the components has resulted in the requirements for improved determination of faults. This will lead towards large area components having surface areas of over a few metres but with component or feature sizes on the micrometre scale. These requirements have also imposed stringent requirements on the metrology of the components. Consequently, the measurement techniques required for these components are exacting as they have to be able to fit in with the normal production of components as well as being able to detect any small defects.

Currently there are a number of ways of determining the surface roughness of a sample; however, these methodologies are typically suited to small surface area objects. These methodologies can be categorised into line profiling, areal profiling or areal integrating techniques. These methodologies have been widely employed in the aerospace industry to certify adherence to respective standards. These methodologies include moving a stylus across the surface, white light interferometry, speckle imaging and microscopy. These methods, however, are currently limited by their point-by-point data acquisition and small field of view. As such, there is a need to improve these methods to image large areas. However, all of these techniques are limited either by contamination, measurement speed or measurement field of view.

A way of overcoming these issues is to use optical techniques. In particular the use of lasers and speckle imaging needs further exploration. Laser speckle imaging exploits random scattering and interference of coherent light from a surface to determine if there are differences on the surface. Out of all the speckle based techniques, speckle correlation techniques for surface topology measurements have been investigated the most. Nevertheless, all of these measurement techniques have yet to overcome the issues of measuring large components. The issues for these to overcome are one or more of the speed, area and/or resolution of the techniques. As such, there is a need to improve the methodology to make it useful for the aerospace, and other industries that require high tolerances over large area components such as automotive, marine, nuclear and medical for example.

### SUMMARY OF THE DISCLOSURE

According to a first aspect there is provided a method of measuring the surface roughness of a component using an optical system comprising a tunable laser light source and a camera system, the method comprising: (a) positioning the component to be measured upon a mount in front of the optical system; (b) capturing a first image of the component at a first location at a first wavelength λ₁, and then capturing a second image of the component at the first location at a second wavelength λ₂; (c) correlating the first and second images; (d) determining the Speckle Statistical Correlation (SSC) coefficient of the first and second images; (e) plotting the SSC coefficient for the combined first and second images ; (f) calculating the roughness parameters Rₐ and R_{q} from the SSC coefficient plot; (g) plotting a roughness map for the imaged surface from the calculated roughness parameters Rₐ and R_{q}; (h) moving the optical system to a new location and repeating steps (b) to (g) at the new location, and repeating these steps until a desired area of the component has been imaged; and (i) stitching the roughness maps for each location to form an overall roughness map for the desired area of the component.

The disclosure is beneficial as it provides a non-contact, non-destructive surface roughness measurement at long distances. The method also reduces the overall measurement times of the component. It is also able to provide an accurate and repeatable measurement process that can easily be automated.

The first and second images may be cropped before correlating the images.

The roughness map may be created by averaging pixels.

The averaging may be done using ISO 25178.

The overall roughness map may be displayed to a user and saved for later reference.

The stitching performed in step 10 may be carried out by inputting an image size for the images and defining a stitching sequence, defining an overlap between the images to be stitched together, and merging the images according to the stitching sequence to form the overall roughness map.

The optical system may be mounted on automatic translation stages having 5 degrees of freedom.

The tunable laser light source may be coupled to an optical fibre for delivering the light for illuminating the surface of component.

The optical system may project structured light from the laser source onto the surface of the component.

The imaging system may comprise two cameras for stereoscopic imaging.

The component to be imaged may be part of a gas turbine engine.

The skilled person will appreciate that except where mutually exclusive, a feature described in relation to any one of the above aspects may be applied mutatis mutandis to any other aspect. Furthermore, except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 shows a component to be measured using a camera system in accordance with the method of the present disclosure;

FIG. 2a is an embodiment of an optical system for use in the present disclosure; FIG. 2b is an alternative embodiment of an optical system for use in the method of the present disclosure;

FIG. 3a presents an alternative embodiment of a stereoscopic imaging system for use in the present disclosure, FIG. 3b presents method steps required for using a stereoscopic imaging system;

FIG. 4a presents an alternative embodiment of a structured light projecting system for use in the present disclosure, FIG. 4b presents method steps required for using the structured light projecting system;

FIGS. 5a-e present an example of combining the speckle imaging of a sample;

FIG. 6 is a flow chart of an optional stitching technique for use in combining the images of the present disclosure;

FIG. 7 presents a flow chart for the method of the present disclosure.

FIG. 8 shows the embodiment presented in FIG. 2b tested for surface roughness measurement of an object 450 mm×210 mm in size measured using the method of the present disclosure.

### DETAILED DESCRIPTION OF THE DISCLOSURE

Aspects and embodiments of the present disclosure will now be discussed with reference to the accompanying drawings. Further aspects and embodiments will be apparent to those skilled in the art.

As outlined above, the use of speckle imaging for determining surface roughness is known. The technique utilises a coherent light, such as that produced by a laser, to illuminate a surface. The incident light scatters from the surface of an object and randomly interferes such that when the reflected light is imaged it produces a series of bright and dark patterns—it is these patterns that are termed as speckles. A second image can then be taken, with the speckle size modified by the wavelength of light or an adjustment to the speckle size. This works because Spectral Speckle Correlation (SSC), i.e. the correlation of two speckle images, exploits the relationship between the wavelength of the illumination source used and the size of the individual speckle. This is calculated by determining the speckle statistics from the two images which have been correlated. The conditions required for correlating the two consecutive speckle patterns are: (a) the Root Mean Square (RMS) of the surface roughness is greater than the wavelength of the coherent light source; (b) the image forms fully developed speckles (contrast equals 1) and that the surface height probability is Gaussian; and (c) the image is formed by an isotropic and homogeneous material whereby shadowing, multiple reflections and volume scattering are neglected. The theoretical equation governing the relationship between the correlation coefficient (SSC) and the RMS surface roughness (R_{q}) can be written as:

$$S SC = exp ( - {( \frac{4 π Δ λ}{{λ}_{1} {λ}_{2}} {R}_{q} cos θ )}^{2} ) \qquad ( Equation 1 )$$

Wherein λ₁ and λ₂ are the illumination wavelengths used to obtain the speckle images. Δλ is the difference between the illumination wavelengths λ₁ and λ₂. θ is the angle of illumination, which is equal to the angle of observation. Additionally, assuming the surface under test has a Gaussian distribution R_{q} can be related to the average roughness Rₐ by the following.

$${R}_{a} = \sqrt{\frac{2}{π}} {R}_{q} \qquad ( Equation 2 )$$

Consequently, from this the average roughness of a workpiece can be determined.

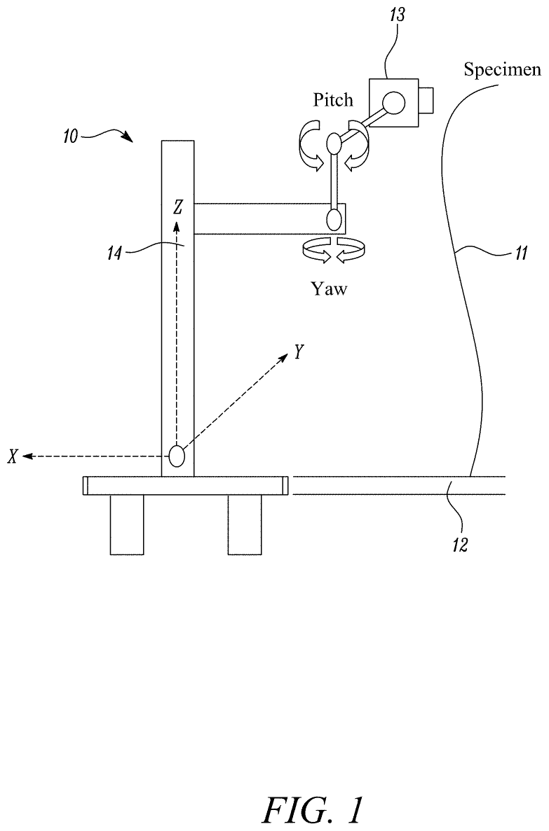

An example of a camera system 10 to be used for large area measurements is shown in FIG. 1. Here the specimen 11 is mounted on a stage 12. The imaging device/camera 13 is then mounted on a translation stage 14 having 5 degrees of freedom. This allows the camera 13 to move in pitch and yaw as well as in the x,y and z directions. An alternative to this would be for the camera to be fixed and for the sample to move relative to the camera with the same degrees of freedom. With the camera system able to move with its 5 degrees of freedom the observation angle can be adjusted to image the entire workpiece.

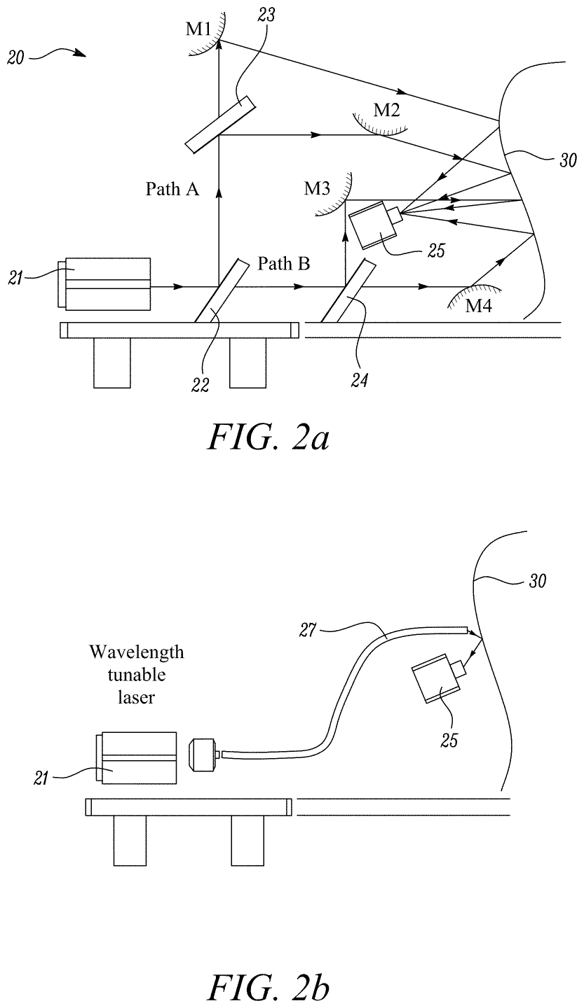

There are a number of options for illuminating the sample. The requirement for the light to be coherent means that a laser system must be employed. However, the choice of light source can be any suitable laser or light source with a large degree of coherence. In the example shown in FIGS. 2a and 2b a wavelength tunable laser is used this can be an argon laser (others HeNe, dye, CO₂ and diode lasers for example). FIG. 2a shows an example of the optical setup 20 suitable for performing the method of the disclosure. In the optical setup the output from the laser can be directed onto the sample using beam splitters and mirrors to produce a large illumination area. In the figure, which is an example only, the light from the laser is directed to a first angled beam splitter 22, this allows 50% of the light to be reflected along path A and the remaining 50% to travel along path B. The light along path A is directed onto a second angled beam splitter 23, which again splits the light directing half to mirror M1 and half to mirror M2. Mirrors M1 and M2 direct this portion of light onto the workpiece 30 to be imaged. The light travelling along path B is directed to a third beam splitter 24 which directs the light along this path to Mirrors M3 and M4. These in turn, like mirrors M1 and M2, direct the light to separate points on the sample surface. The light reflected from the workpiece is collected and imaged by camera 25. It is desirable that the intensity of the beams down the two paths are equal so that the intensity resulting from the scattering will be equivalent across the imaged surface. The person skilled in the art would appreciate that there are a large number of variations of optical components which could achieve similar illumination profiles. The angle of the illumination light to the angle of the camera can be set to any suitable value. This for example, could be where the angle of illumination is equal to the angle of reflection. However, these can be varied relative to each other. For curved surfaces other angles may be desirable.

A second alternative optical illumination system is presented in FIG. 2b. Here the light emitted the laser 21 is coupled in an optical fibre 27 before being directed to the surface of the workpiece 30. The reflected light from this is then captured by camera 25. The example shows the use of only a single optical fibre. However, it will be appreciated if the beam can be split along the optical fibre to produce more than one illumination point.

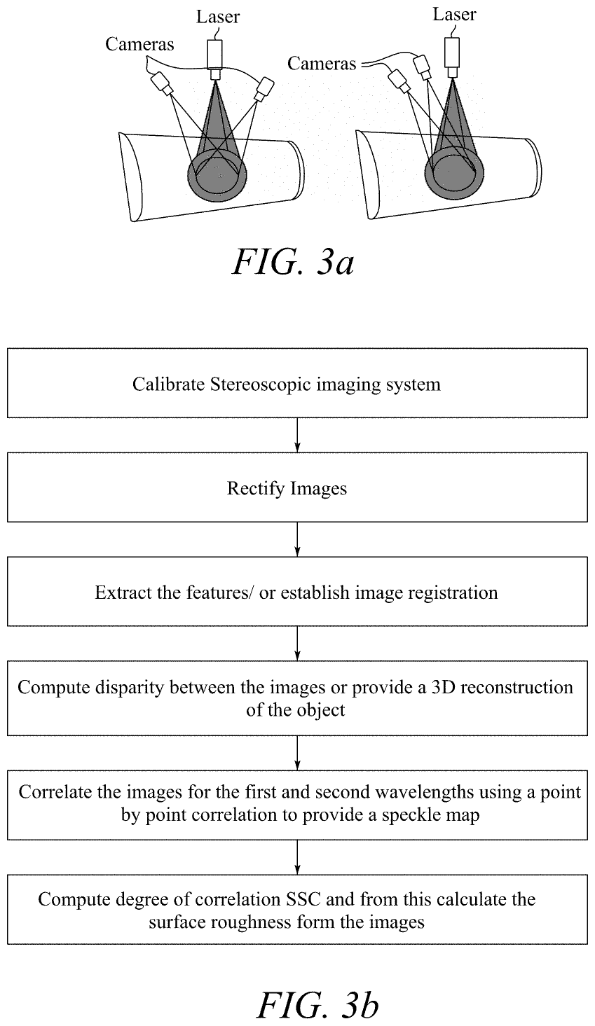

A further alternative optical set up is to project structured light onto the surface of the object to be imaged. Structured light is a process of projecting a known pattern onto the object with the way that this pattern deforms from the reflection off a surface allows the vision system to calculate depth and surface information of the formations on the surface of the object to be determined. For the system the structured light needs to be applied at two different wavelengths λ₁ and λ₂. An example of an imaging setup using structured light is shown in FIG. 3a. The processing steps for this technique are shown in FIG. 3b. The first step is to calibrate the light projector and the camera. The second step is to use the projector to project the fringe patterns from the laser system, so that the light has features. This is done at both λ₁ and λ₂ in order to produce the two requisite images for the SSC correlation. The third step can be done in one of two ways. The first option is to use phase wrap/unwrap which is a technique used to segment the phase map and to reduce the discontinuities in the phase calculation between adjacent pixels. The second option is to use pattern recognition and triangulation of points on the stripes. Typically to use such technique is to combine binary grey codes, Fast Fourier Transform (FFT) and pattern recognition for the 3D reconstruction of the imaged object. This allows for the two images to be correlated and combined. From the two images a depth map of the imaged surface can be created, which is done in the fourth step. The fifth step produces a point by point correlation of λ₁ and λ₂ images to produce the speckle maps. With the speckle images for the point reproduced the SSC correlation for each area imaged can be created and the surface roughness R_{q} determined in the sixth step.

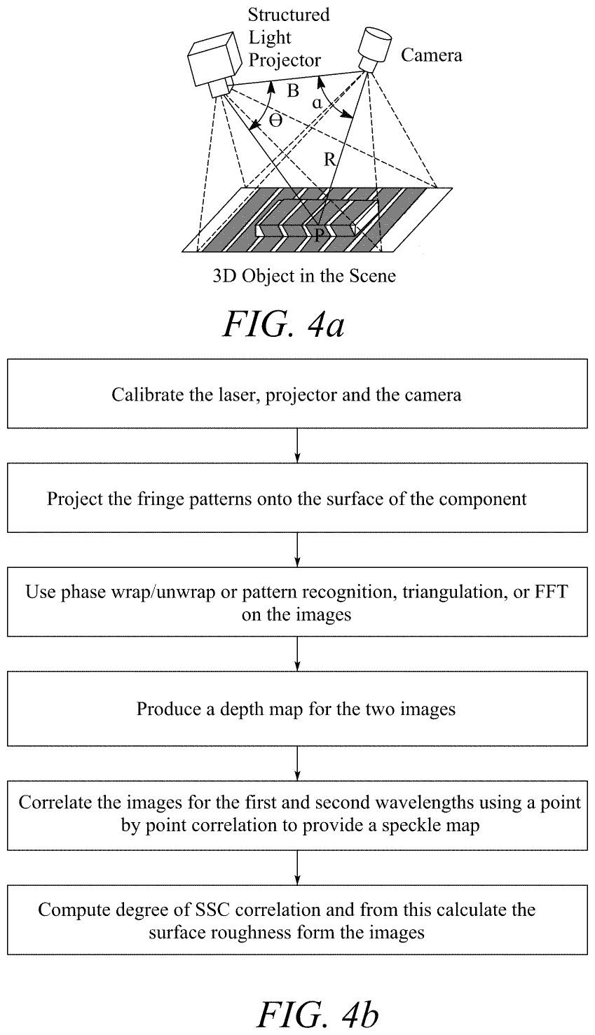

An alternative to the above set up and process is shown in FIG. 4. In this, rather than using multiple illumination points the system then uses two cameras to capture a stereovision image of the surface. In order to use such a system the laser illumination spot is expanded to create a large area spot on the surface of the object. Then relative to the spot the cameras can be positioned at the desired point relative to the illumination spot. An example of this is shown in FIG. 4a. In doing this both of the cameras can be mounted onto separate 5 degree of freedom movement stages, such that the cameras can be moved and positioned as desired. To obtain desirable results in this case the beam needs to be expanded to a desirable size this can be done using any suitable means. The illumination spot size may be any suitable size. This spot size will be dependent upon the shape and size of the object or the desired power and intensity required for the laser spot. With the optical set up created the images need to be resolved and the process to obtain the SSC parameters in order to obtain the RMS surface roughness R_{q}. This process is set out in FIG. 4b. The first step is to calibrate the stereo system. The second step is to obtain the images and to rectify these. This is done at two different wavelengths of light using a tunable laser. With the obtained images at different wavelengths the surface features can be extracted and recorded in the third step. The fourth step uses the two images to calculate any disparities and forms a 3D reconstruction of the images. With the 3D reconstruction and the two images being linked to the same position on the surface, a correlation between the two images can be obtained for the images obtained at the two different wavelengths. This allows for a point by point correlation of the images at λ₁ and λ₂ to form a speckle image for the object from the two cameras with 3D information. In this step, co-registration techniques can also be used to correlate the corresponding point clouds, such as Iterative Closest Point (ICP), PROCRUSTES etc. An optional step that can be used to improve the quality of the images is to use an interpolation technique on the point cloud; this technique may be a Nearest Neighbour (NN), or moving Plane (MP). From the figures and their associated point clouds the SSC correlation and the RMS surface roughness R_{q} can be plotted. Following the first four steps allows for a calibrated 3D map of the inspected surface to be produced. In order to produce high quality images using this option to obtain the images is finding clear features of the surface of the object in order to obtain good registration between the two images.

The camera used for these different optical systems can be any suitable camera system such as Charge Coupled Device (CCD) or alternatively Complementary Metal Oxide on Silicon (CMOS) could be used.

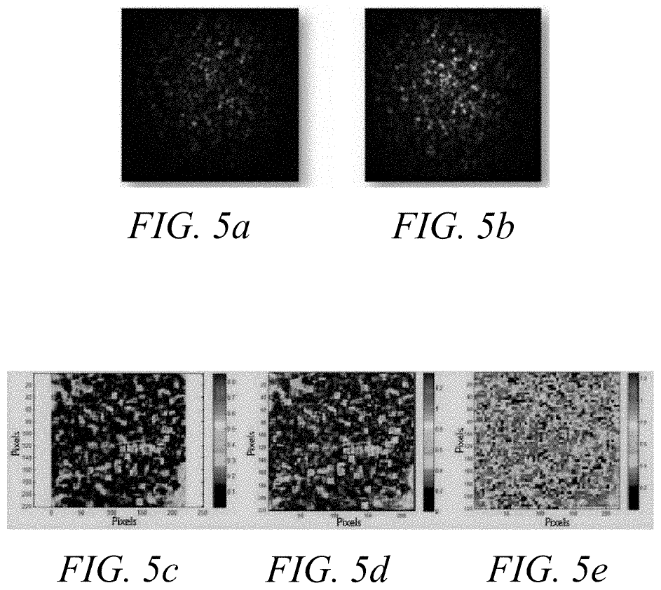

The image obtained from the optical system then needs to be processed to determine the surface roughness for the sample for the particular illumination point. Image processing is used to convert the output from each of the camera pixels to obtain the SSC values. To process this, the images captured at λ₁ and λ₂ are correlated using appropriate software. This for example could be created in MATLAB™ modelling software or other suitable processing software. Example images of the steps of this process is shown in FIG. 5. This figure presents an example correlation of an image obtained using the optical system presented in FIG. 2b. FIGS. 5a and 5b show an example of the image obtained by the system at wavelengths λ₁ and λ₂, respectively. A correlation plot is then determined as shown 5c; this utilises an intensity correlation of the speckle images through a pixel-pixel correlation. From this, the SSC plot is converted into a surface roughness plot using equations 1 and 2 as shown in FIG. 5d. A final step is then to sub-sample the plot using the camera calibration parameters, as each pixel on the camera corresponds to a specific area on the sample. By setting these calibration parameters an evaluation length, which is done in pixels, is chosen based on ISO standard 25178 part 6. This standard relates to Geometric Product Specifications (GPS)—surface texture areal, with part 6 relating to the classification of methods for measuring the surface texture. This final processing step is shown in FIG. 5e, in this example the evaluation length was set to 4 pixels.

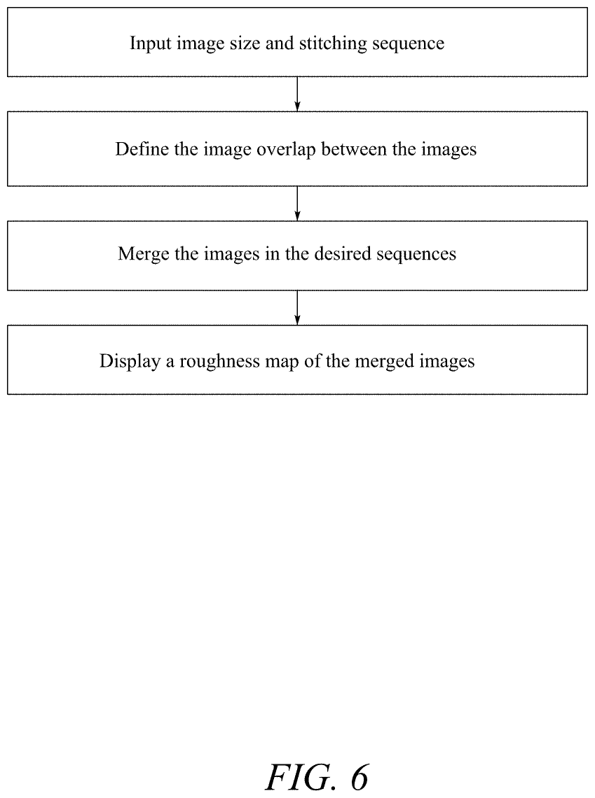

In order to achieve large area processing with high accuracy the process must be repeated on different points on the sample. To image accurately in this way the separate images must have an overlap in the imaged sample area. This overlap allows the images to be stitched together, such that multiple smaller images can be used to produce an image of a much larger object. For example, the overlap may be 50% of the image, or 45%, 40%, 35%, 30%, 25%, 20%, or 15% of the image. The processing of the stitching is set out in FIG. 6. In the first step the images are input into the system along with information regarding the size of the area that the image covers. This is input along with the desired stitching sequence. This will vary depending upon the number of images that are being stitched together to form the final image. With the stitching order determined, the second step sets the level of overlap between the images. As discussed above, this can be any suitable value and will depend on the accuracy required in the final image. With the parameters input for the first two steps, the third step merges the images in the desired stitching order. The fourth step displays a final output from the merged image to display a roughness map that is larger than that of the original input images. In doing so the high-resolution surface roughness plots for large scale objects can be obtained by keeping the similar experimental parameters.

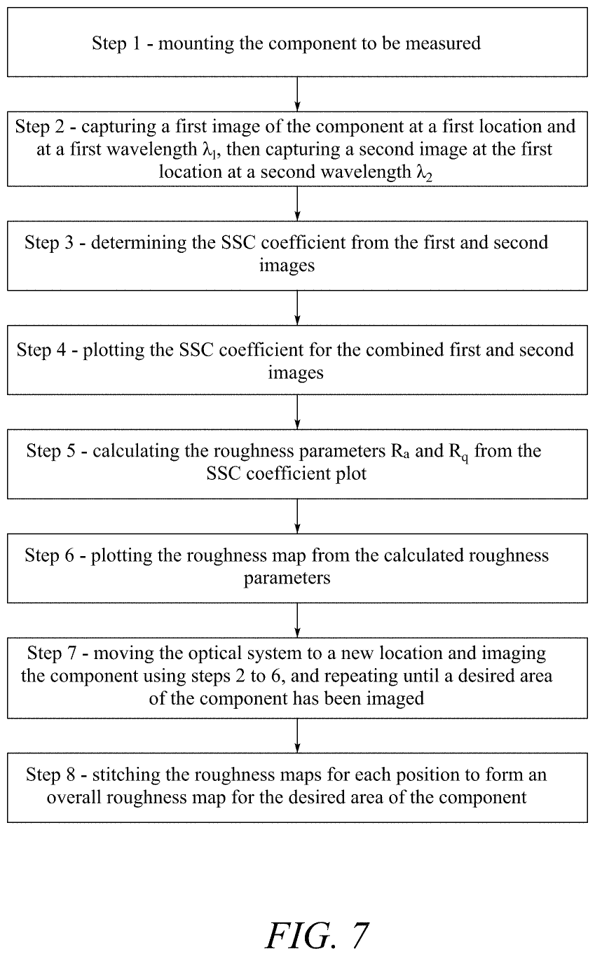

The processing steps that can be used to produce an image for a large scale object are set out in FIG. 7. Step 1 mounts the component to be measured on a stage. Calibration of the system may then be performed at the home location. This ensures that the system is in position to start the imaging and that all the translation stages are in their correct position for imaging. Depending upon the types of objects to be imaged the calibration point for different objects may be different depending upon the requirements of the system. Step 2 moves the equipment to a first location to be imaged. Depending upon the object to be imaged, the position of the first image may be selectively chosen, this could be either in the direct centre or towards a desired edge of corner. With the optical equipment in the first imaging location an image is captured at the first wavelength λ₁ to produce image A. The system then captures an image at the same location as that of image A, but this time at a different wavelength λ₂ to produce image B. With the two images acquired these may then be cropped for their correlation processing. Cropping is used to restrict the image to only the pixels of interest. This can either be a user defined crop or the crop can be automatically fixed around the centre of the image. In step 3 the SSC coefficient is determined for the first and second images, obtained in step 2. The SSC coefficient is determined using Equation 1 and plotted for the cropped area images. Step 4 plots the SSC coefficient for the combined images. Step 5 utilises the SSC coefficient plot to determine the R_{q} and Rₐ parameters. Step 6 plots a roughness map. This step may be done using pixel averaging based upon the ISO standard 25178 or with any other suitable means. The roughness map may then also be saved for the first position is saved in a designated folder. The scanning then moves onto the next location in step 7 and repeats Steps 2-6 at one or more locations, until the scanning is complete. With all the scanning complete the images can be stitched together to form a roughness map for the overall object in step 8. An additional step may be included which displays this image and saves the output to the designated folder. After this the imaging process comes to an end.

If the area imaged is larger than a single image then stitching of the images needs to be performed to produce a larger imaging result. The multiple images need to be stitched together prior to processing the surface roughness calculation. One way to achieve the accurate stitching together of the images is to have external inputs that illustrate the camera or inspected-object position and orientation for each capture. If using the 3D imaging system of FIGS. 3 and 4 a transformation matrix can then be derived and applied on each depth map to align it together. This is similar to the approach that is used when 2D images are stitched together. Other techniques that can be used would be apparent to the skilled person in the art. Some of the other techniques involving computation may be more complex, as the object surface may not have distinguishable features to register. In these cases, physical or optical markers can be applied to the surface of the imaged object and used as markers to register and align multiple images. If texture projection is used as part of the structured light system of FIG. 4, a surface registration technique such as ICP may be used to align the images. If the object has features already present on the surface or there are faults such as cracks then 2D feature extraction and matching methods such as SIFT and FAST can be used to determine the transformation matrix between the different captures and align the point cloud scenes.

The area covered in each image from the camera can be any suitable size, providing that there is enough resolution to be able to determine the surface roughness of the workpiece that is being imaged. For example, the images may be under 100 mm×100 mm. There is no restriction on the images being square they may also be able rectangular and could be any in any suitable aspect ratio, as will be appreciated by the person skilled in the art. The number of images that are required to stitch the images together to form a full-scale image of the component will depend upon the size of the object, the size of the initial images and the amount of overlap used for each of the images.

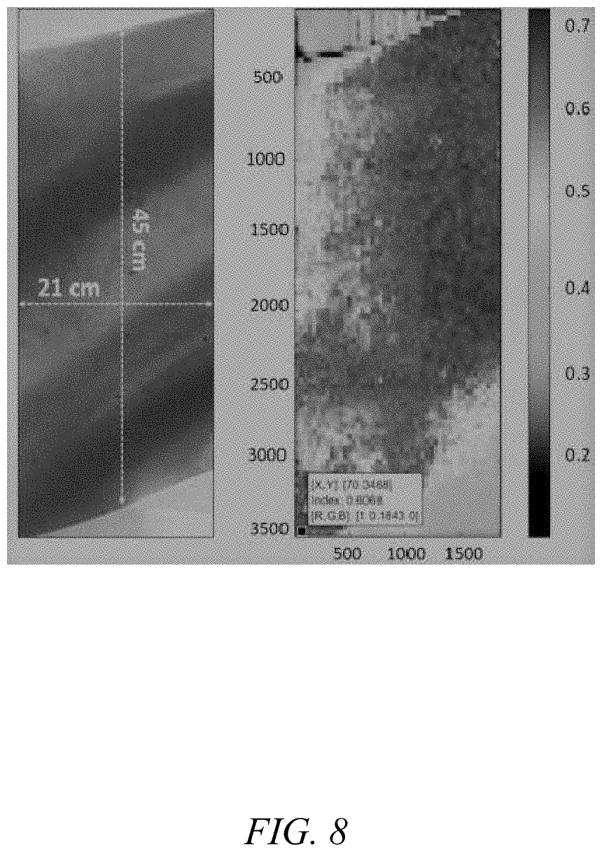

An example embodiment was tested for imaging an object 450 mm×210 mm is shown in FIG. 8. In order to capture this image, a fibre illumination technique was used, similar to that shown in FIG. 2b. The fibre illumination system coupled to an argon laser operating at 488 nm for λ₁ and 514.5 nm for λ₂ and the camera being similar to a probe head were scanned across the large area to obtain the speckle images. Each frame corresponded to an area of 60 mm×45 mm at a working distance of 160 mm. All of the images were stitched together having an overlap of 50%. The imaging system was automated and performed the entire image capture through a predefined trajectory to obtain all the images required by the imaging system. A stitching algorithm was used as performing the method as set out in FIG. 6.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method of measuring the surface roughness of a component using an optical system comprising a tunable laser light source and a camera system, the method comprising:
(a) positioning the component to be measured upon a mount in front of the optical system;
(b) capturing a first image of the component at a first location at a first wavelength λ₁, and then capturing a second image of the component at the first location at a second wavelength 2₂;
(c) determining the Speckle Statistical Correlation (SSC) coefficient of the first and second images;
(d) plotting the SSC coefficient for the combined first and second images;
(e) calculating the roughness parameters Rₐ and R_{q} from the SSC coefficient plot;
(f) plotting a roughness map for the imaged surface from the calculated roughness parameters Rₐ and R_{q};
(g) moving the optical system to a new location and repeating steps (b) to (f) at the new location, and repeating these steps until a desired area of the component has been imaged; and
(h) stitching the roughness maps for each location to form an overall roughness map for the desired area of the component.

2. The method as claimed in claim 1, wherein the first and second images are cropped before correlating the images.

3. The method as claimed in claim 1, wherein the roughness map is created by averaging pixels.

4. The method as claimed in claim 1, wherein the overall roughness map is displayed to a user and saved for later reference.

5. The method as claimed in claim 1, wherein the stitching performed in step 10 is carried out by inputting an image size for the images and defining a stitching sequence, defining an overlap between the images to be stitched together, and merging the images according to the stitching sequence to form the overall roughness map.

6. The method as claimed in claim 1, wherein the optical system is mounted on automatic translation stages having 5 degrees of freedom.

7. The method as claimed in claim 1, wherein the tunable laser light source is coupled to an optical fibre for delivering the light for illuminating the surface of component.

8. The method as claimed in claim 1, wherein the optical system projects structured light from the laser source onto the surface of the component for the illumination of the component being imaged.

9. The method as claimed in claim 1, wherein the optical system comprises two cameras for stereoscopic imaging.

10. The method as claimed in claim 1, wherein the component to be imaged is part of a gas turbine engine.

11. A blade for a gas turbine engine having its surface roughness measured by the method of claim 1.
